(19) United States
(12) Patent Application Publication
(10) Pub. No.: US 2026/0127757 A1
(43) Pub. Date: May 7, 2026

(54) MULTI-VIEW-BASED 3D OBJECT DETECTION METHOD AND SYSTEM

(71) Applicants: Zhejiang Normal University, Jinhua (CN); BEIJING GEEKPLUS TECHNOLOGY CO., LTD., Beijing (CN); Hangzhou Zongheng Communication Co., Ltd, Hangzhou (CN)

(72) Inventors: Xinzhong ZHU, Jinhua (CN); Huiying XU, Jinhua (CN); Hongbo LI, Beijing (CN); Ke SHENG, Jinhua (CN); Wei SHI, Shanghai (CN); Weifeng SU, Hangzhou (CN); Xiao HUANG, Jinhua (CN)

(73) Assignees: Zhejiang Normal University, Jinhua (CN); BEIJING GEEKPLUS TECHNOLOGY CO., LTD., Beijing (CN); Hangzhou Zongheng Communication Co., Ltd, Hangzhou (CN)

(21) Appl. No.: 19/379,792

(22) Filed: Nov. 5, 2025

(30) Foreign Application Priority Data
Nov. 6, 2024 (CN) 202411575301.7

(51) Int. Cl. G06T 7/70; G06N 3/0464; G06T 5/10; G06T 7/80; G06V 10/80

(52) U.S. Cl. CPC G06T 7/70; G06N 3/0464; G06T 5/10; G06T 7/80; G06V 10/803; G06T 2207/30244; G06V 2201/07

(57) ABSTRACT

The provided is a multi-view-based 3D (three-dimensional) object detection method and system. This method is optimized based on an existing three-dimensional object detection model PETR. Specifically, 3DRoPE is introduced to replace an original 3D position encoding mode, and learnable parameters are set for 3D position information to enhance adaptability. In addition, the pose geometric information of multi-view cameras is fused into the position embedding of each view image, so that the capability of this model for processing the complex spatial relationship is further improved. After being trained using the NuScenes dataset, this model can receive real-time image input from a plurality of cameras and output accurate 3D object detection results, which significantly improves perception accuracy and safety in autonomous driving environments.

### CROSS-REFERENCE TO THE RELATED APPLICATIONS

This application is based upon and claims priority to Chinese Patent Application No. 202411575301.7, filed on Nov. 6, 2024, the entire contents of which are incorporated herein by reference.

### TECHNICAL FIELD

The present invention relates to the technical field of computer vision, and more specifically, to a multi-view-based 3D object detection method and system.

### BACKGROUND

At present, there are mainly two methods based on the bird's-eye-view (BEV) perspective. One method converts two-dimensional image features into dense BEV features, thereby performing subsequent tasks such as object detection using the BEV features. The other method, referred to as a sparse query-based method, performs interaction directly using global three-dimensional (3D) queries and image features through an attention mechanism, and updates the 3D queries using a decoder to complete the detection task. The first method requires conversion of image features into explicit BEV features, which demands more computational resources and is therefore less efficient. The second method more directly and efficiently utilizes 3D queries and image features for interaction, resulting in lower computational resource requirements and higher computational efficiency compared to the first method. However, the second method still exhibits a gap in detection accuracy and related performance metrics. For practical applications, the second method clearly has a significant advantage.

However, the current implementation of this method exhibits insufficient detection accuracy. Although the detection speed is relatively fast, the low detection accuracy limits the applicability of this method, particularly for real-world autonomous driving scenes.

Therefore, how to improve detection accuracy of the sparse query-based method while maintaining the computational efficiency advantage of this method is an issue urgently to be resolved by those skilled in the art.

### SUMMARY

In view of this, the present invention provides a multi-view-based 3D object detection method and system, to resolve a problem in Background part.

To achieve the above objective, the present invention provides the following technical solutions.

A multi-view-based 3D object detection method includes:
constructing a multi-view 3D object detection model in an autonomous driving scene based on three-dimensional object detection PETR improvement; replacing the original 3D position embedding in original three-dimensional object detection PETR by using 3D position embedding 3DRoPE based on rotation embedding ROPE; setting a learnable parameter for to-be-embedded 3D position information; and fusing pose geometric information of multi-view cameras into 3D position embedding 3DRoPE of an image under each view to obtain an improved 3D object detection model;
training the improved 3D object detection model by using a NuScenes dataset in an autonomous driving scene to obtain a multi-view 3D object detection model in the autonomous driving scene; and
inputting images acquired by the multi-view cameras in the autonomous driving scene into the 3D object detection model to obtain a 3D object detection result in the autonomous driving scene.

Preferably, the 3D position embedding 3DRoPE based on rotation embedding RoPE includes:
dividing 3D query and 3D point position information embedding of a 2D image into three parts, namely, for each 3D point position Pₙ(p^{x}, p^{y}, p^{z}), applying 1-dimensional rotation embedding RoPE to position information of xyz according to a sequence of x, y and z, and embedding and concatenating positions of three dimensions to form a complete 3D position embedding 3DRoPE, defined as:
generating a rotation matrix of different dimensionality position information according to the position information of different axes xyz:

$${R}_{x} = {e}^{i {θ}_{tx} {p}^{x}} , {R}_{y} = {e}^{i {θ}_{ty} {p}^{y}} , {R}_{z} = {e}^{i {θ}_{tz} {p}^{z}}$$

where Rₓ, R_{y}, R_{z}∈C^{N×(d}^{_{head}}^{/6)}, Rₓ, R_{y}, R_{z} represent rotation matrices of the position information of different axes, d_{head} represents a number of channels of image features and 3D queries, θₜ represents a frequency used in sinusoidal and cosine encoding methods to extend two-dimensional complex rotation to high-dimensional rotations corresponding to image and 3D query vectors, θₜₓ, θ_{ty}, θ_{tz}=10000^{-t/(d}^{_{head}}^{/6)}, t∈{0, 1, . . . , d_{head}/6}, and θₜₓ, θ_{ty}, θ_{tz} represent frequencies of rotations for position information of different axes, respectively;
dividing related image feature vectors and 3D query vectors obtained from images captured by the multi-view cameras through a convolutional neural network into three equal parts according to the number of channels to apply rotations of position information of different dimensions:

$${Q}_{x} = \{ {Q}_{1} , {Q}_{2} , … , {Q}_{n - 5} , {Q}_{n - 4} \}$$

$${Q}_{y} = \{ {Q}_{3} , {Q}_{4} , … , {Q}_{n - 3} , {Q}_{n - 2} \}$$

$${Q}_{z} = \{ {Q}_{5} , {Q}_{6} , … , {Q}_{n - 1} , {Q}_{n} \}$$

$${Q}_{x}^{′} = {Q}_{x} {e}^{i {θ}_{tx} {p}^{x}} , {Q}_{y}^{′} = {Q}_{y} {e}^{i {θ}_{ty} {p}^{y}} , {Q}_{z}^{′} = {Q}_{z} {e}^{i {θ}_{tz} {p}^{z}}$$

$${Q}_{ros} = cat ( {Q}_{x}^{′} , {Q}_{y}^{′} , {Q}_{z}^{′} )$$

where Qₓ, Q_{y}, Q_{z} represent the vectors divided into three parts, Qₓ′, Q_{y}′, Q_{z}′ represent vectors after rotation containing position information of each dimension, Qᵣₒₛ represents a vector obtained by concatenating the three rotated vectors into a complete position embedding vector containing three-dimensional point position information, and cat represents concatenation;
processing embedding vectors of the image features and the 3D queries obtained from images captured by the multi-view cameras through a convolutional neural network by attention computation to represent a relative positional relationship between the image features and the 3D queries in an attention matrix:

$${A}_{( n , m )}^{′} = Re [ {q}_{n}^{′} {k}_{m}^{′ *} ] = Re [ {q}_{n} {k}_{m}^{*} {e}^{i ( n - m ) θ} ]$$

where A′_{(n,m)} represents the attention matrix after computation, qₙ′, k′ₘ* represent rotated queries and keys, e^{i(n-m)θ} represents the result of the attention computation, and n and m represent two different positions.

Preferably, setting the learnable parameter for the to-be-embedded 3D position information includes:

$${P}_{a}^{3 d} = α ( {p}^{x} , {p}^{y} , {p}^{z} )$$

where

$${P}_{a}^{3 d}$$

represents adaptive 3D point position information, α represents the learnable parameter, and p_{y} and p^{z} represent 3D point positions.

Preferably, fusing the pose geometric information of the multi-view cameras into the 3D position embedding 3DRoPE of the image under each view includes:
calculating a pose [q̅ₙ, tₙ] of each-view camera using intrinsic and extrinsic parameters of the each-view camera, where q̅ₙ represents a quaternion vector indicating rotation, and tₙ represents a position vector;
capturing corresponding geometric attributes using a Fourier transform:

$$γ ( x \vert [ {f}_{1} , … , {f}_{k} ] ) = [ sin ( {f}_{1} π x ) , cos ( {f}_{1} π x ) , … ]$$

where γ( ) represents a Fourier transform function, [f₁, . . . , fₖ] are k frequencies evenly sampled from [0, fₘₐₓ], and x represents attributes of each camera pose;
mapping geometric attributes after the Fourier transform to dimensions corresponding to image features using a multi-layer perceptron (MLP):

$${G}_{n}^{e} = M L {P}_{e n c} ( γ [ {\overline{q}}_{n} , {t}_{n} ] )$$

where

$${G}_{n}^{e}$$

represents the pose geometric embedding of each-view camera, q̅ₙ represents a quaternion vector indicating rotation, and tₙ represents a position vector; and
adding

$${G}_{n}^{e}$$

to the position embedding to form a complete pose-enhanced position embedding.

A multi-view-based 3D object detection system includes:
a model construction module, configured to construct a multi-view 3D object detection model in an autonomous driving scene based on three-dimensional object detection PETR improvement; replace original 3D position embedding in original three-dimensional object detection PETR by using 3D position embedding 3DRoPE based on rotation embedding RoPE; set a learnable parameter for to-be-embedded 3D position information; and fuse pose geometric information of multi-view cameras into 3D position embedding 3DRoPE of an image under each view to obtain an improved 3D object detection model;
a model training module, configured to train the improved 3D object detection model by using a NuScenes dataset in an autonomous driving scene to obtain a multi-view 3D object detection model in the autonomous driving scene; and
a model detection module, configured to input images acquired by the multi-view cameras in the autonomous driving scene into the 3D object detection model to obtain a 3D object detection result in the autonomous driving scene.

It can be known from the technical solutions that, compared with the conventional technology, the present invention provides a multi-view-based 3D object detection method and system. The three-dimensional object detection PETR is improved, a relative position embedding method 3DRoPE is designed for three-dimensional point position information based on the rotational position embedding RoPE, and a learnable parameter is set for the 3D point position information, so that the model can adaptively learn relative position relationships at different scales. Meanwhile, the influence of multi-view geometric information on relative position computation is considered, and the pose geometric information of cameras in different views is embedded into the position embedding of image features in each view. Moreover, these improvements are only made to the 3D position information embedding, without substantially increasing the computational complexity of the model, thereby maintaining the computational efficiency advantage. In addition, detection accuracy is improved to a certain extent. The precise 3D object detection results obtained significantly enhance perception accuracy and safety in autonomous driving environments.

### BRIEF DESCRIPTION OF THE DRAWINGS

To more clearly illustrate the technical solutions in the embodiment of the present invention or in the prior art, the drawings required to be used in the description of the embodiment or the prior art are briefly introduced below. It is obvious that the drawings in the description below are merely embodiment of the present invention, and those of ordinary skill in the art can obtain other drawings according to the drawings provided without creative efforts.

FIG. 1 is a schematic flow chart of a method according to the present invention;

FIG. 2 is a schematic diagram of modules of a system according to the present invention;

FIG. 3 is a schematic diagram of a structure of an improved model according to the present invention;

FIG. 4 is a schematic diagram of a structure of 3DRoPE designed in the present invention;

FIG. 5 is a schematic diagram of a pose-enhanced position embedding structure according to the present invention;

FIGS. 6A-6B show an example diagram of detection results of a model according to the present invention;

FIG. 7A is a visualization of detection results of a first frame of the same scene during model detection;

FIG. 7B is a visualization of detection results of a second frame of the same scene during model detection;

FIG. 7C is a visualization of detection results of a third frame of the same scene during model detection;

FIG. 8A is a visualization of detection results of a first scene during model detection;

FIG. 8B is a visualization of detection results of a second scene during model detection; and

FIG. 8C is a visualization of detection results of a third scene during model detection.

### DETAILED DESCRIPTION OF THE EMBODIMENTS

The following clearly and completely describes the technical solutions in the embodiment of the present invention with reference to the drawings in the embodiment of the present invention. It is clear that the described embodiment are merely a part rather than all of the embodiment of the present invention. Based on the embodiment in the present invention, all other embodiment obtained by those of ordinary skill in the art without making any creative effort fall in the protection scope of the present invention.

An objective of the present invention is to provide a multi-view-based 3D object detection method and system. The method includes the following steps: constructing a multi-view 3D object detection model based on PETR improvement, and improving a 3D position embedding method in the original PETR method; designing 3DRoPE suitable for a 3D position to replace an absolute position embedding method in the original PETR based on a relative position embedding method of rotational position embedding (RoPE), setting a learnable parameter aiming at to-be-encoded 3D position information, enabling a model to adapt to relative position relationships at different scales; meanwhile, considering the influence of geometric information of multi-view cameras on 3D position encoding, adding the geometric information of the multi-view cameras into 3D position embedding; training the improved model by using an autonomous driving dataset NuScenes to obtain a multi-view 3D object detection model in an autonomous driving scene; and inputting images acquired by the multi-view cameras in the autonomous driving scene into the 3D object detection model to obtain a 3D object detection result in the autonomous driving scene. The present invention has made improvements to the problems existing in the embedding method related to 3D position information in the previous detection methods and has proposed a new relative position embedding method related to 3D position information, which enhances the capability of object localization and identification in autonomous driving scenes. Therefore, the present invention provides a solution for the defects of the existing 3D object detection method.

To make the objectives, features, and advantages of the present invention more apparent and understandable, the following describes the present invention in detail with reference to the accompanying drawings and specific implementations.

### Embodiment 1

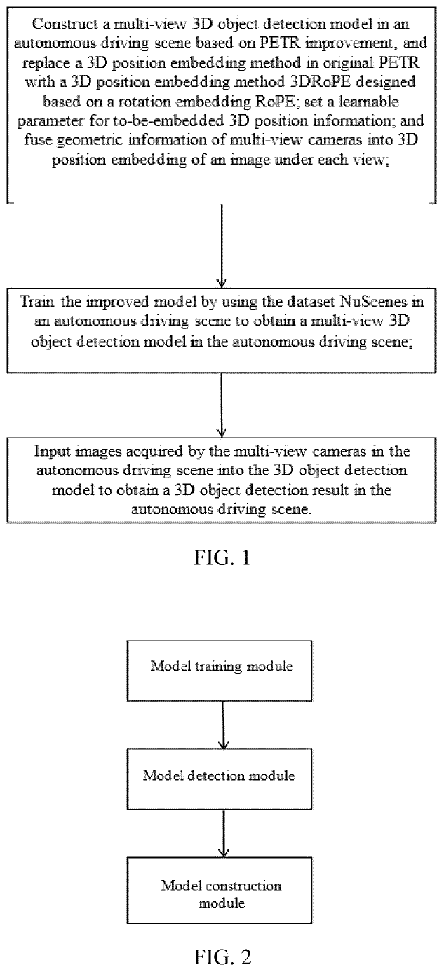

Referring to FIG. 1, an embodiment of the present invention discloses a multi-view-based 3D object detection method, which includes:
step 1: constructing a multi-view 3D object detection model in an autonomous driving scene based on three-dimensional object detection PETR improvement, and replacing a 3D position embedding method in original PETR with a 3D position embedding method 3DRoPE designed based on a rotation embedding ROPE; setting a learnable parameter for to-be-embedded 3D position information; fusing pose geometric information of multi-view cameras into 3D position embedding of an image under each view;
step 2: training the improved model by using the dataset NuScenes in an autonomous driving scene to obtain a multi-view 3D object detection model in the autonomous driving scene; and
step 3: inputting images acquired by the multi-view cameras in the autonomous driving scene into the 3D object detection model to obtain a 3D object detection result in the autonomous driving scene.

Specifically, PETR (Position Embedding Transformation for Multi-View 3D Object Detection) is an advanced multi-view 3D object detection algorithm widely applied in autonomous driving and other fields requiring high-precision spatial perception. As one of the most advanced 3D detection models at present, PETR is established upon the success of previous object detection methods and integrates innovative geometric encoding and multi-view feature fusion technologies, thereby further improving detection accuracy and model robustness. The reasons for selecting PETR as the 3D object detection algorithm are as follows: (1) Ray Embedding: PETR introduces an innovative ray embedding mechanism for projecting from 2D image pixels into 3D space. Each pixel represents a geometric relationship between this pixel and the camera through ray embedding, which enables the model to infer the three-dimensional position of an object more accurately, thereby improving detection accuracy, and exhibiting excellent performance particularly in multi-camera surround scenes. (2) Transformer-based Self-Attention Mechanism: PETR adopts a Transformer architecture and fuses image features from a plurality of views through a self-attention mechanism. This approach enables the model to capture richer global contextual information and significantly enhances the capability of spatial relationship modeling in complex scenes. (3) 3D Query Mechanism (3D Queries): PETR introduces a 3D query mechanism during the detection process, and the model directly localizes objects in the feature space through these 3D queries. This mechanism not only enhances three-dimensional spatial perception capability of the model but also effectively handles object occlusion problems in complex scenes. (4) Balance Between Accuracy and Efficiency: Through efficient fusion of multi-view images and precise ray embedding, PETR achieves lower computational cost while ensuring detection accuracy. This balance allows PETR to meet both speed and accuracy requirements in tasks such as autonomous driving, which demand high real-time performance. (5) Flexible Scalability: PETR possesses high scalability in design and can be easily adapted to various types of 3D scenes and camera configurations, and is particularly suitable for large-scale autonomous driving perception tasks. The flexible geometric encoding method of PETR also provides stability for the model in complex environments.

With the innovative ray embedding, multi-view fusion, and Transformer framework, PETR has become an advanced model in the field of multi-view 3D object detection. With the outstanding performance, PETR becomes an important reference model in fields such as autonomous driving, smart cities, and robot navigation, can handle various complex spatial perception tasks and provides new possibilities for the development of 3D detection technology.

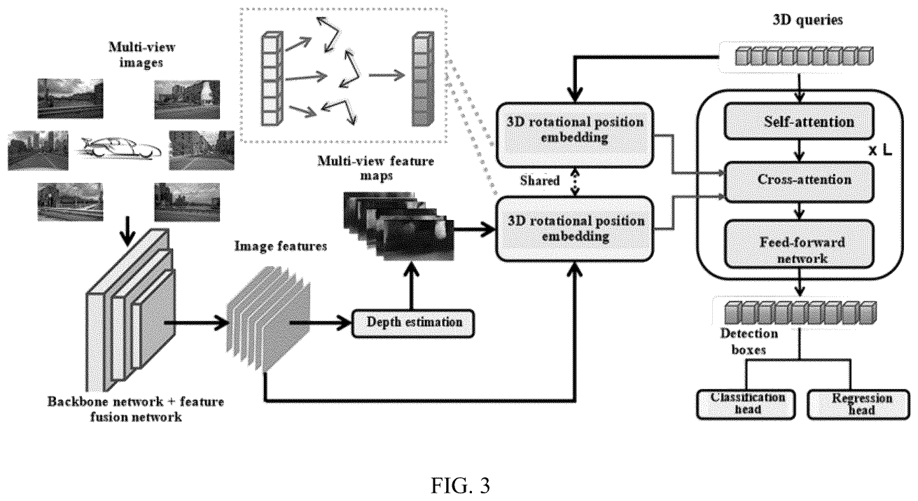

In a specific embodiment, in step 1, the structure of the improved model is as shown in FIG. 3. First, multi-view images are obtained and passed through a backbone network and a feature pyramid to obtain multi-view image features. These image features are then processed by a depth estimation network to obtain depth maps of the multi-view images. Subsequently, 3D positions of the image features are transformed into a unified world coordinate system using the depth maps and intrinsic and extrinsic parameter information of the multi-view cameras to correspond to 3D queries. Then, 3D position embeddings are generated by using 3DRoPE in combination with the image features and the 3D position information thereof, as well as the 3D query and the 3D position information thereof, and the 3D position embeddings are sent into a subsequent L-layer decoder for computation to obtain a corresponding 3D object detection frame for detecting 3D objects.

Specifically, the depth information of multi-view image features is estimated by using a depth estimation network, and the pixel position information in 2D images is transformed into 3D point position information under a unified world coordinate system by using the intrinsic and extrinsic parameters of each-view camera. Therefore, 2D images possess position information consistent with the characteristics of 3D queries, enabling the generation of structurally consistent 3D position embeddings through the designed 3DRoPE and explicitly reflecting the relative positional relationship between queries and image features in subsequent attention computation.

In a specific embodiment, a 3DRoPE suitable for 3D position information embedding is designed based on the rotational position embedding (RoPE), where 3DRoPE is a relative position embedding method different from the absolute position embedding methods adopted by previous approaches.

In a specific embodiment, a relative position embedding method 3DRoPE is designed based on the rotational position embedding (RoPE) to replace the original ray position embedding method in PETR. First, the depth information of image feature pixels is estimated by using a depth estimation network, and the position information of image features from different views is unified into a world coordinate system consistent with the 3D queries by using the obtained depth information in combination with the intrinsic and extrinsic parameters of each-view camera. This unifies the 2D image position information with the 3D position information of the 3D queries for subsequent position embedding. The 3DRoPE cleverly utilizes the properties of complex 2D rotation to embed the 3D position information of 3D points into the subsequent queries and keys in the form of complex rotation, forming the respective position embedding of image features and 3D queries. Thereafter, in the attention matrix between queries and keys, the relative positional relationship between queries and keys is represented, which facilitates more precise object localization by the model.

A learnable parameter is set for the 3D point position information of the image features and 3D queries to be embedded, enabling the model to adaptively learn relative positional relationships at different scales. Meanwhile, considering the impact of pose geometric information of multi-view cameras on relative position computation across different views, the pose geometry information of the camera at different views is further integrated into the position embedding of image features under each view, and multi-view pose geometry-enhanced 3D position embeddings are generated by combining the multi-view camera pose geometry with the original 3D position embedding, which allows the model to more accurately compute the relative positional relationships between images and 3D queries.

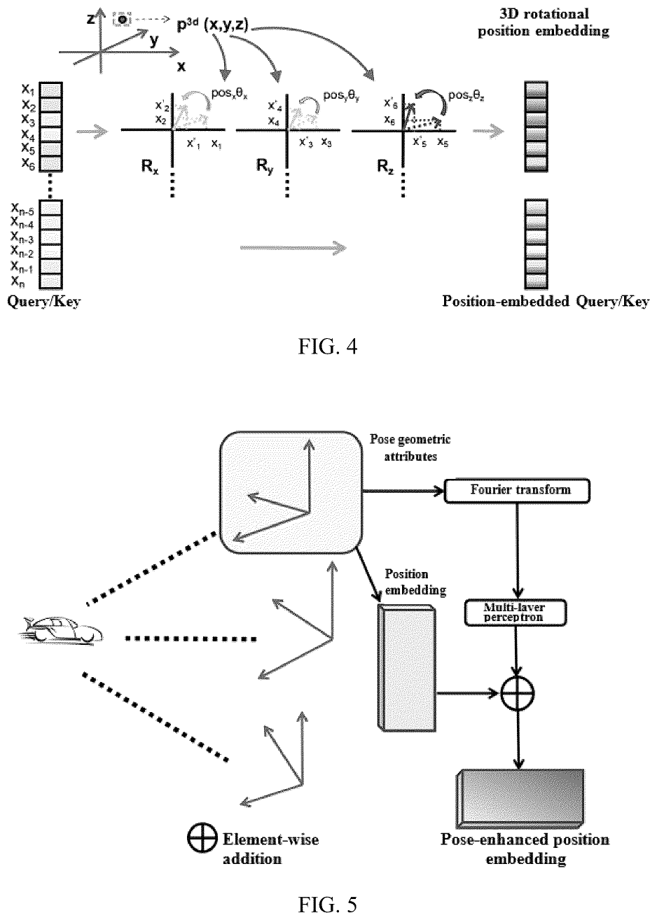

Specifically, the 3D position embedding 3DRoPE based on rotational embedding RoPE is shown in FIG. 4. The 3D point position information of both the 3D queries and 2D images is divided into three parts. For each 3D point Pₙ (p^{x}, p^{y}, p^{z}), the position information along x, y, and z dimensions is processed using a 1-dimensional ROPE in the order of x, y, z. The three dimensional position embeddings are then concatenated to form a complete 3D position embedding, namely 3DRoPE. The definition of 3DRoPE is as follows:
a rotation matrix of different dimensionality position information is generated according to the position information of different axes xyz:

$${R}_{x} = {e}^{i {θ}_{tx} {p}^{x}} , {R}_{y} = {e}^{i {θ}_{ty} {p}^{y}} , {R}_{z} = {e}^{i {θ}_{t z} {p}^{z}}$$

where Rₓ, R_{y}, R_{z}∈C^{N×(d}^{_{head}}^{/6)}, d_{head} represents the number of channels of the image features and 3D queries, θₜ represents the frequency used in the sine and cosine encoding method, which here extends the complex 2D rotation to high-dimensional rotations corresponding to the image and 3D query vectors. Specifically, θₜₓ, θ_{ty}, θ_{tz}=10000^{-t/(d}^{_{head}}^{/6)}, t∈{0, 1, . . . , d_{head}/6}. The feature vectors and 3D query vectors are divided into three parts along the channel dimension to apply rotations corresponding to different dimensional position information:

$${Q}_{x} = \{ {Q}_{1} , {Q}_{2} , … , {Q}_{n - 5} , {Q}_{n - 4} \}$$

$${Q}_{y} = \{ {Q}_{3} , {Q}_{4} , … , {Q}_{n - 3} , {Q}_{n - 2} \}$$

$${Q}_{z} = \{ {Q}_{5} , {Q}_{6} , … , {Q}_{n - 1} , {Q}_{n} \}$$

$${Q}_{x}^{′} = {Q}_{x} {e}^{i {θ}_{tx} {p}^{x}} , {Q}_{y}^{′} = {Q}_{y} {e}^{i {θ}_{ty} {p}^{y}} , {Q}_{z}^{′} = {Q}_{z} {e}^{i {θ}_{tz} {p}^{z}}$$

$${Q}_{r o s} = cat ( {Q}_{x}^{′} , {Q}_{y}^{′} , {Q}_{z}^{′} )$$

where Qₓ, Q_{y}, Q_{z} represent the vectors divided into three parts, Q′ₓ, Q′_{y}, Q′_{z} represent vectors after rotation containing position information of each dimension, Qᵣₒₛ represents a vector obtained by concatenating the three rotated vectors into a complete position embedding vector containing three-dimensional point position information. The relative positional relationships between the image and 3D queries are explicitly represented in the attention matrix by using the respective embedding vectors of the image and 3D queries through attention computation:

$${A}_{( n , m )}^{′} = Re [ {q}_{n}^{′} {k}_{m}^{′ ⋆} ] = Re [ {q}_{n} {k}_{m}^{*} {e}^{i ( n - m ) θ} ]$$

Specifically, this formula takes the attention matrix computation of 1-dimensional RoPE as an example, which can be analogously applied to 3DRoPE, as the characteristics of attention matrix computation are consistent. Here, A′_{(n,m)} represents the attention matrix after computation, and

$${q}_{n}^{′} , {k}_{m}^{′ ⋆}$$

are the rotated query and key vectors. According to the properties of rotation in complex numbers, as shown in the above formula, the attention matrix result contains e^{i(n-m)θ}, and n and m are two different positions. In this way, the attention matrix result contains the relative positional relationship between the query and key.

Specifically, 3DRoPE, through the properties of rotation computation during attention calculation, reflects the relative distances between queries and keys in the attention matrix. This relative position embedding method enhances the object localization capability of the model, thereby facilitating improved performance in 3D object detection tasks.

Specifically, a learnable parameter is set for the 3D position information of image features and 3D queries by using the inherent properties of the ROPE method, which enables the model to adaptively learn relative positional relationships at different scales:

$${P}_{α}^{3 d} = α ( {p}^{x} , {p}^{y} , {p}^{z} )$$

where

$${P}_{α}^{3 d}$$

is adaptive 3D point position information, and a represents the learnable parameter.

The fusion of the pose geometric information of multi-view cameras into the 3D position embedding of images under each view is shown in FIG. 5. Considering the impact of different views on relative position computation in a multi-view scene, the pose geometric information of multi-view cameras is embedded into the 3D position embedding of images under the corresponding view. First, the pose [q̅ₙ, tₙ] of each-view camera is calculated using the intrinsic and extrinsic parameters of each-view camera, where q̅ₙ represents a quaternion vector indicating rotation, and tₙ represents a position vector. Inspired by NeRF, a Fourier transform is first applied to capture the corresponding geometric attributes:

$$γ ( x \vert [ {f}_{1} , … , {f}_{k} ] ) = [ sin ( {f}_{1} π x ) , cos ( {f}_{1} π x ) , … ]$$

where γ( ) represents a Fourier transform function, [f₁, . . . , fₖ] are k frequencies evenly sampled from [0, fₘₐₓ], and x represents attributes of each camera pose.

Then, the geometric attributes obtained after the Fourier transform are mapped to the dimensions corresponding to the image features by using an MLP, so as to facilitate subsequent fusion with the position embeddings:

$${G}_{n}^{e} = ML {P}_{e n c} ( γ [ {\overline{q}}_{n} , {t}_{n} ] )$$

where

$${G}_{n}^{e}$$

represents pose geometric embedding of each-view camera, and

$${G}_{n}^{e}$$

and the position embedding are added to form a complete pose-enhanced position embedding.

Specifically, in step 2, the NuScenes dataset, released by Motional, is an autonomous driving dataset specifically designed for 3D object detection, scene understanding, and trajectory planning tasks. The NuScenes dataset is currently one of the most widely used multi-modal datasets in the field of autonomous driving, containing a large amount of annotated data from a plurality of sensors and covering diverse traffic scenes and complex urban environments. The NuScenes dataset provides a standardized evaluation platform for autonomous driving research and has promoted the development of tasks such as 3D object detection, tracking, and behavior prediction.

This embodiment also discloses a multi-view 3D object detection system in an autonomous driving scene, as shown in FIG. 2, which includes: a model construction module, configured to construct a multi-view 3D object detection model in an autonomous driving scene based on PETR improvement, and replace a 3D position embedding method in original PETR with a 3D position embedding method 3DRoPE designed based on a rotation embedding ROPE; set a learnable parameter for to-be-embedded 3D position information; and fuse pose geometric information of multi-view cameras into 3D position embedding of an image under each view;
a model training module, configured to train the improved model by using the dataset NuScenes in an autonomous driving scene to obtain a multi-view 3D object detection model in the autonomous driving scene; and
a model detection module, configured to input images acquired by the multi-view cameras in the autonomous driving scene into the 3D object detection model to obtain a 3D object detection result in the autonomous driving scene.

### Embodiment 2

In this embodiment, based on Embodiment 1, object detection is performed on multi-view images captured by multi-view cameras in autonomous driving scenes through specific experiments to verify the beneficial effects of the method of the present invention.

Specifically, the experiments of this embodiment are conducted on a Linux operating system, using PyCharm Community as the integrated development environment, and the model framework is implemented based on the Python programming language.

Specifically, the main hardware configuration for the experiments is as follows: Ubuntu 20.04 64-bit operating system; processor (CPU) Xeon® Platinum 8352V; graphics cards (GPU) four Nvidia Geforce RTX 4090 (24 G each); memory (RAM) 90 GB. The deep learning development environment includes PyCharm 2023.5.17, Python 3.8, CUDA 11.3, and PyTorch 1.11.0.

Specifically, the NuScenes dataset adopted by this experiment is an autonomous driving dataset specifically designed for 3D object detection, scene understanding, and trajectory planning tasks.

Specifically, the dataset provides annotations for 10 object categories, such as vehicles, pedestrians, cyclists, and traffic signs, covering common traffic participants. The dataset includes annotations for over 1000 scenes, each lasting 20 seconds, and provides fine-grained 3D bounding box annotations at a 2 Hz frequency, including information on object category, position, orientation, velocity, and dimensions. The dataset is captured using 6 surround-view cameras, 5 LiDAR sensors (one surround LiDAR and four corner LiDARs), one millimeter-wave radar, an IMU (Inertial Measurement Unit), and GPS, providing comprehensive environmental perception. The dataset includes annotations for over 1000 scenes, each lasting 20 seconds, and provides fine-grained 3D bounding box annotations at a 2 Hz frequency, including information on object category, position, orientation, velocity, and dimensions.

Specifically, the experiments use PETR as the baseline model, with a batch size set to 4, the number of epochs for traversing the entire training dataset set to 24, and a learning rate of 0.002. A cosine annealing strategy is adopted, and AdamW is used as the optimizer.

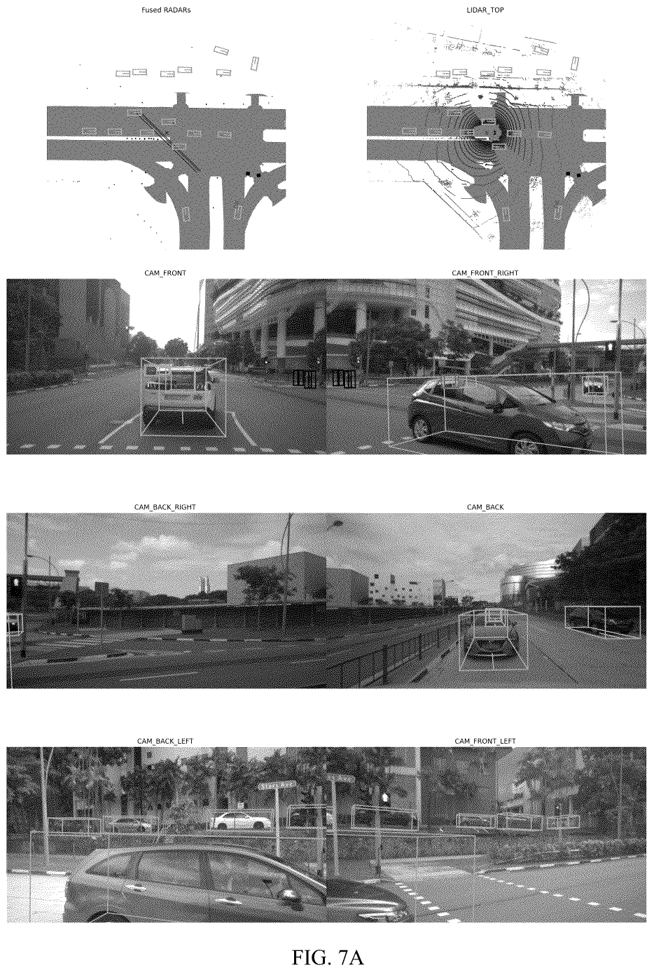

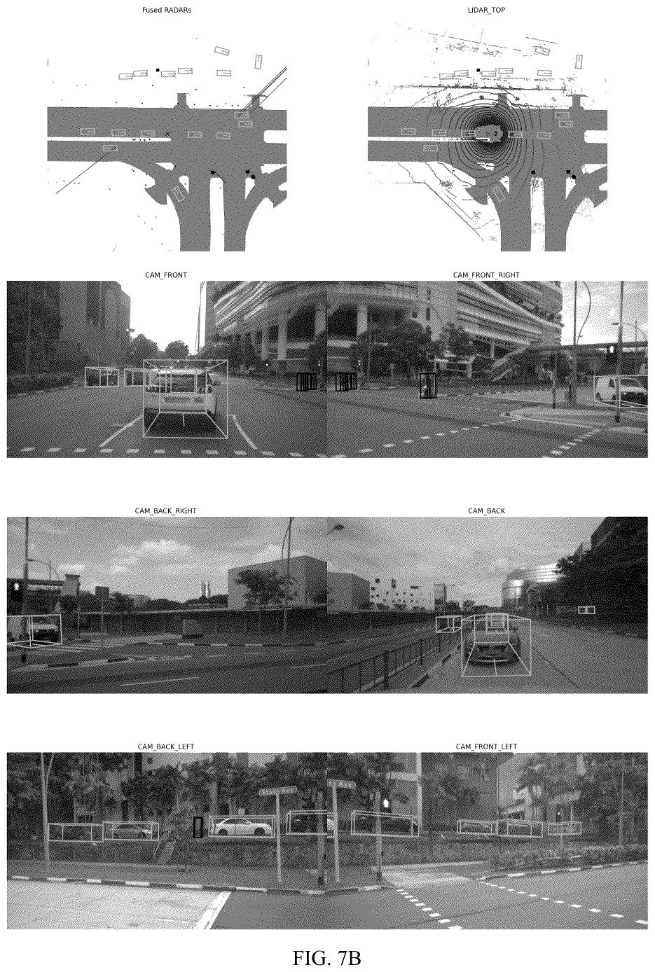

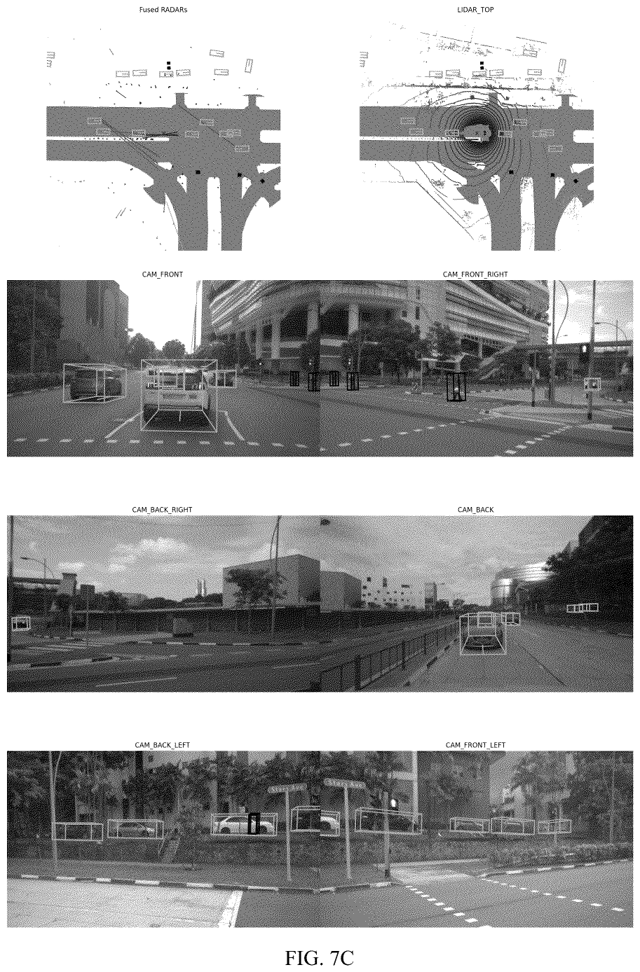

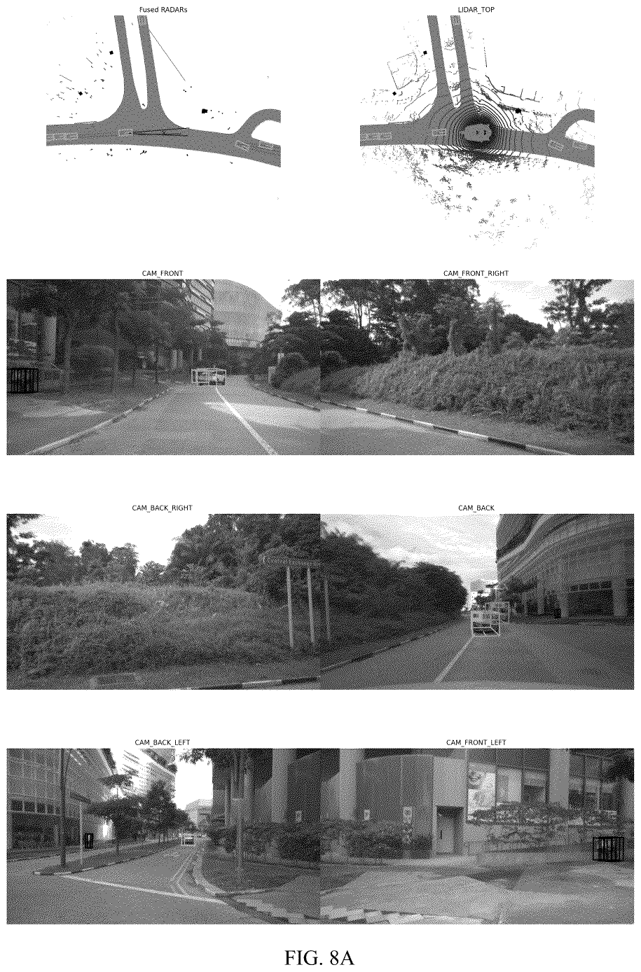

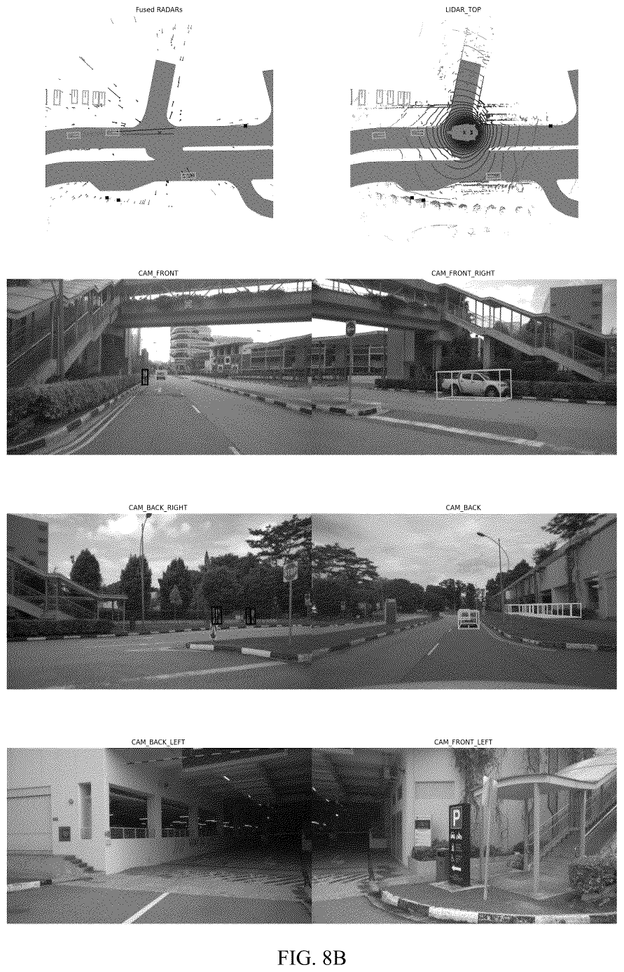

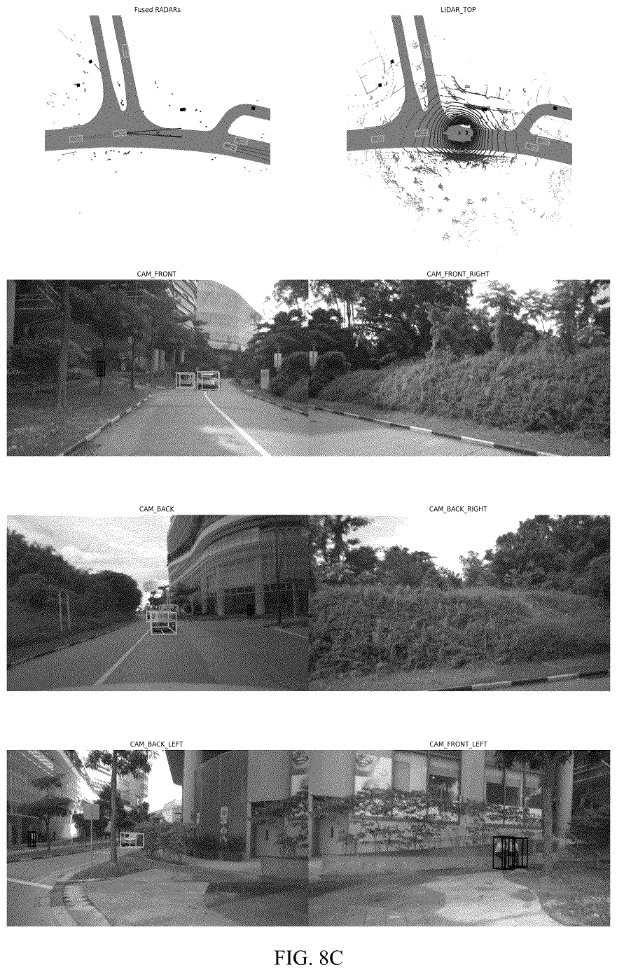

Specifically, the experiments of this embodiment include comparisons between the improved method, PETR, and other current mainstream methods, including BEVDet, BEVDepth, DETR3D, CAPE, 3DPPE, BEVFormer, and DD3D. Experiments are conducted on both the test set and the validation set, using different image resolutions and different backbone networks. The evaluation involves seven metrics: mean average precision (mAP), nuScenes detection score (NDS), mean translation error (mATE), mean scale error (mASE), mean orientation error (mAOE), mean velocity error (mAVE), and mean attribute error (mAAE). The comparative results show that, whether on the test set or the validation set, the present invention exhibits advantages to varying degrees across different metrics, as shown in Table 1. Additionally, visualization of object detection results for the method of the present invention is provided: FIGS. 7A-7C show visualization of detection results for different frames of the same scene, and FIGS. 8A-8C show visualization of detection results for different scenes. Each of FIGS. 7A-7C includes detection results from six cameras with different views and two radar perspectives. It can be observed that nearly all objects in different frames are detected, including both near-field objects and some small far-field objects. Similarly, FIGS. 8A-8C also include detection results from six camera views and two radar perspectives. It can be seen that, whether in complex or simple scenes, the objects in the scene are accurately detected.

TABLE 1
Experimental results on the validation set of the NuScenes dataset

| | Backbone | | | | mATE | mASE | mAOE | mAVE | mAAE |
|---|---|---|---|---|---|---|---|---|---|
| Method | network | Resolution | mAP↑ | NDS↑ | ↓ | ↓ | ↓ | ↓ | ↓ |
| BEVDet | Res-50 | 704 × 256 | 0.298 | 0.379 | 0.725 | 0.279 | 0.559 | 0.860 | 0.245 |
| BEVDepth-S | Res-50 | 704 × 256 | 0.315 | 0.367 | 0.702 | 0.271 | 0.621 | 1.042 | 0.315 |
| DETR3D | Res-50 | 1408 × 512 | 0.303 | 0.374 | 0.860 | 0.278 | 0.437 | 0.967 | 0.235 |
| CAPE | Res-50 | 1408 × 512 | 0.337 | 0.380 | 0.778 | 0.280 | 0.568 | 0.963 | 0.224 |
| PETR | Res-50 | 1408 × 512 | 0.339 | 0.403 | 0.748 | 0.273 | 0.539 | 0.907 | 0.203 |
| 3DPPE | Res-50 | 1408 × 512 | 0.370 | 0.433 | 0.689 | 0.279 | 0.524 | 0.828 | 0.202 |
| 3DRoPE | Res-50 | 1408 × 512 | 0.380 | 0.440 | 0.682 | 0.272 | 0.534 | 0.815 | 0.197 |
| PETR | VoV-99 | 800 × 320 | 0.378 | 0.426 | 0.746 | 0.272 | 0.488 | 0.906 | 0.212 |
| 3DPPE | VoV-99 | 800 × 320 | 0.398 | 0.446 | 0.704 | 0.270 | 0.495 | 0.843 | 0.218 |
| 3DRoPE | VoV-99 | 800 × 320 | 0.399 | 0.450 | 0.670 | 0.263 | 0.483 | 0.849 | 0.211 |

TABLE 2
Experimental results on the test set of the NuScenes dataset

| | Backbone | | | | mATE | mASE | mAOE | mAVE | mAAE |
|---|---|---|---|---|---|---|---|---|---|
| Method | network | Resolution | mAP↑ | NDS↑ | ↓ | ↓ | ↓ | ↓ | ↓ |
| DETR3D | VoV-99 | 1600 × 640 | 0.412 | 0.479 | 0.641 | 0.255 | 0.394 | 0.845 | 0.133 |
| DD3D | VoV-99 | 1600 × 640 | 0.418 | 0.477 | 0.572 | 0.249 | 0.368 | 1.014 | 0.124 |
| BEVDet | VoV-99 | 1600 × 640 | 0.424 | 0.488 | 0.524 | 0.242 | 0.373 | 0.950 | 0.148 |
| BEVFormer-S | VoV-99 | 1600 × 640 | 0.435 | 0.495 | 0.589 | 0.254 | 0.402 | 0.842 | 0.131 |
| PETR | VoV-99 | 1600 × 640 | 0.441 | 0.504 | 0.593 | 0.249 | 0.383 | 0.808 | 0.132 |
| 3DPPE | VoV-99 | 1600 × 640 | 0.460 | 0.514 | 0.569 | 0.255 | 0.394 | 0.796 | 0.138 |
| 3DRoPE | VoV-99 | 1600 × 640 | 0.473 | 0.529 | 0.544 | 0.246 | 0.384 | 0.779 | 0.126 |

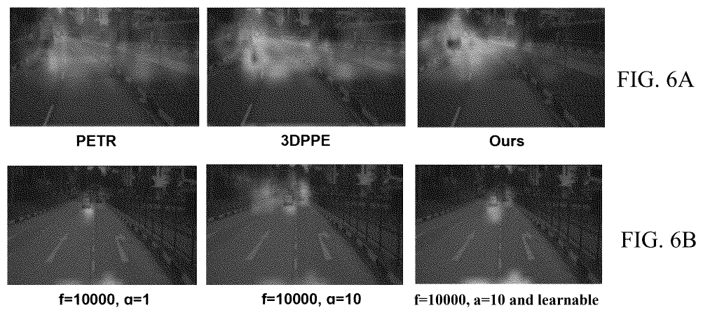

Meanwhile, this embodiment also conducts ablation experiments for each improvement, with results shown in Table 3. Additionally, visualization of the attention matrices for several different methods is provided in FIGS. 6A-6B. FIG. 6A shows a comparison of the attention maps between different methods and the method of the present invention, and FIG. 6B shows a comparison of attention maps with different parameters within the method of the present invention. It can be clearly seen that the different improvements each provide corresponding enhancements. Furthermore, the visualization of the detection results shows that the method of the present invention achieves improvements in practical applications.

TABLE 3
Ablation experiments with different modifications

| # | 3DRoPE | Adaptive | Pose | mAP↑ | NDS↑ |
|---|---|---|---|---|---|
| 1 | | | | 0.378 | 0.426 |
| 2 | ✓ | | | 0.390 | 0.440 |
| 3 | ✓ | ✓ | | 0.397 | 0.447 |
| 4 | ✓ | | ✓ | 0.394 | 0.444 |
| 5 | ✓ | ✓ | ✓ | 0.399 | 0.450 |

The embodiments in the specification are all described in a progressive manner, and each embodiment focuses on differences from other embodiments, and portions that are the same and similar between the embodiments may be referred to each other. Since the apparatus disclosed in the embodiment corresponds to the method disclosed in the embodiment, the description is relatively simple, and reference may be made to the partial description of the method.

The above description of the disclosed embodiment enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to these embodiments shown herein but is to be accorded the broadest scope consistent with the principles and novel features disclosed herein.

1. A multi-view-based 3D object detection method, comprising:
constructing a multi-view 3D object detection model in an autonomous driving scene based on three-dimensional object detection PETR improvement; replacing original 3D position embedding in original three-dimensional object detection PETR by using 3D position embedding 3DRoPE based on rotation embedding RoPE; setting a learnable parameter for to-be-embedded 3D position information; and fusing pose geometric information of multi-view cameras into 3D position embedding 3DRoPE of an image under each view to obtain an improved 3D object detection model;
training the improved 3D object detection model by using a NuScenes dataset in an autonomous driving scene to obtain a multi-view 3D object detection model in the autonomous driving scene; and
inputting images acquired by the multi-view cameras in the autonomous driving scene into the 3D object detection model to obtain a 3D object detection result in the autonomous driving scene.

2. The multi-view-based 3D object detection method according to claim 1, wherein the 3D position embedding 3DRoPE based on rotation embedding RoPE comprises:
dividing 3D query and 3D point position information embedding of a 2D image into three parts, namely, for each 3D point position Pₙ(p^{x}, p^{y}, p^{z}), applying 1-dimensional rotation embedding RoPE to position information of xyz according to a sequence of x, y and z, and embedding and concatenating positions of three dimensions to form a complete 3D position embedding 3DRoPE, defined as:
generating a rotation matrix of different dimensionality position information according to the position information of different axes xyz:
$${R}_{x} = {e}^{i {θ}_{tx} {p}^{x}} , {R}_{y} = {e}^{i {θ}_{ty} {p}^{y}} , {R}_{z} = {e}^{i {θ}_{tz} {p}^{z}}$$
wherein Rₓ, R_{y}, R_{z}∈C^{N×(d}^{_{head}}^{/6)}, Rₓ, R_{y}, R_{z} represent rotation matrices of the position information of different axes, d_{head} represents a number of channels of image features and 3D queries, θₜ represents a frequency used in sinusoidal and cosine encoding methods to extend two-dimensional complex rotation to high-dimensional rotations corresponding to image and 3D query vectors, θₜₓ, θ_{ty}, θ_{tz}=10000^{-t/(d}^{_{head}}^{/6)}, t∈{0, 1, . . . , d_{head}/6}, and θₜₓ, θ_{ty}, θ_{tz} represent frequencies of rotations for position information of different axes, respectively;
dividing related image feature vectors and 3D query vectors obtained from images captured by the multi-view cameras through a convolutional neural network into three equal parts according to the number of channels to apply rotations of position information of different dimensions:
$${Q}_{x} = \{ {Q}_{1} , {Q}_{2} , … , {Q}_{n - 5} , {Q}_{n - 4} \}$$
$${Q}_{y} = \{ {Q}_{3} , {Q}_{4} , … , {Q}_{n - 3} , {Q}_{n - 2} \}$$
$${Q}_{z} = \{ {Q}_{5} , {Q}_{6} , … , {Q}_{n - 1} , {Q}_{n} \}$$
$${Q}_{x}^{′} = {Q}_{x} {e}^{i {θ}_{tx} {p}^{x}} , {Q}_{y}^{′} = {Q}_{y} {e}^{i {θ}_{ty} {p}^{y}} , {Q}_{z}^{′} = {Q}_{z} {e}^{i {θ}_{tz} {p}^{z}}$$
$${Q}_{r o s} = cat ( {Q}_{x}^{′} , {Q}_{y}^{′} , {Q}_{z}^{′} )$$
wherein Qₓ, Q_{y}, Q_{z} represent the vectors divided into three parts, Q′ₓ, Q′_{y}, Q′_{z} represent vectors after rotation containing position information of each dimension, Qᵣₒₛ represents a vector obtained by concatenating three rotated vectors into a complete position embedding vector containing three-dimensional point position information, and cat represents concatenation;
processing embedding vectors of the image features and the 3D queries obtained from images captured by the multi-view cameras through a convolutional neural network by attention computation to represent a relative positional relationship between the image features and the 3D queries in an attention matrix:
$${A}_{( n , m )}^{′} = Re [ {q}_{n}^{′} {k}_{m}^{′ ⋆} ] = R e [ {q}_{n} {k}_{m}^{*} {e}^{i ( n - m ) θ} ]$$
wherein A′_{(n,m)} represents the attention matric after computation,
$${q}_{n}^{′} , {k}_{m}^{′ ⋆}$$
represent rotated queries and keys, e^{i(n-m)θ} represents a result of the attention computation, and n and m represent two different positions.

3. The multi-view-based 3D object detection method according to claim 1, wherein setting the learnable parameter for the to-be-embedded 3D position information comprises:
$${P}_{α}^{3 d} = α ( {p}^{x} , {p}^{y} , {p}^{z} )$$
wherein
$${P}_{α}^{3 d}$$
represents adaptive 3D point position information, α represents the learnable parameter, and p^{y} and p^{z} represent 3D point positions.

4. The multi-view-based 3D object detection method according to claim 1, wherein fusing the pose geometric information of the multi-view cameras into the 3D position embedding 3DRoPE of the image under each view comprises:
calculating a pose [q̅ₙ, tₙ] of each-view camera using intrinsic and extrinsic parameters of the each-view camera, wherein q̅ₙ represents a quaternion vector indicating rotation, and tₙ represents a position vector;
capturing corresponding geometric attributes using a Fourier transform:
$$γ ( x \vert [ {f}_{l} , … , {f}_{k} ] ) = [ sin ( {f}_{l} π x ) , cos ( {f}_{l} π x ) , … ]$$
wherein γ( ) represents a Fourier transform function, [f₁, . . . , fₖ] are k frequencies evenly sampled from [0, fₘₐₓ], and x represents attributes of each camera pose;
mapping geometric attributes after the Fourier transform to dimensions corresponding to image features using a multi-layer perceptron (MLP):
$${G}_{n}^{e} = M L {P}_{enc} ( γ [ {\overline{q}}_{n} , {t}_{n} ] )$$
wherein
$${G}_{n}^{e}$$
represents pose geometric embedding of each-view camera, q̅ₙ represents a quaternion vector indicating rotation, and tₙ represents a position vector; and
adding
$${G}_{n}^{e}$$
to the position embedding to form a complete pose-enhanced position embedding.

5. A multi-view-based 3D object detection system using the multi-view-based 3D object detection method according to claim 1, comprising:
a model construction module, configured to construct the multi-view 3D object detection model in the autonomous driving scene based on the three-dimensional object detection PETR improvement; replace the original 3D position embedding in the original three-dimensional object detection PETR by using the 3D position embedding 3DRoPE based on the rotation embedding RoPE; set the learnable parameter for the to-be-embedded 3D position information; and fuse the pose geometric information of the multi-view cameras into the 3D position embedding 3DRoPE of the image under each view to obtain the improved 3D object detection model;
a model training module, configured to train the improved 3D object detection model by using the NuScenes dataset in the autonomous driving scene to obtain the multi-view 3D object detection model in the autonomous driving scene; and
a model detection module, configured to input the images acquired by the multi-view cameras in the autonomous driving scene into the 3D object detection model to obtain the 3D object detection result in the autonomous driving scene.

6. The multi-view-based 3D object detection system according to claim 5, wherein in the multi-view-based 3D object detection method, the 3D position embedding 3DRoPE based on rotation embedding RoPE comprises:
dividing 3D query and 3D point position information embedding of a 2D image into three parts, namely, for each 3D point position Pₙ(p^{x}, p^{y}, p^{z}), applying 1-dimensional rotation embedding RoPE to position information of xyz according to a sequence of x, y and z, and embedding and concatenating positions of three dimensions to form a complete 3D position embedding 3DRoPE, defined as:
generating a rotation matrix of different dimensionality position information according to the position information of different axes xyz:
$${R}_{x} = {e}^{i {θ}_{tx} {p}^{x}} , {R}_{y} = {e}^{i {θ}_{ty} {p}^{y}} , {R}_{z} = {e}^{i {θ}_{tz} {p}^{z}}$$
wherein Rₓ, R_{y}, R_{z}∈C^{N×(d}^{_{head}}^{/6)}, Rₓ, R_{y}, R_{z} represent rotation matrices of the position information of different axes, d_{head} represents a number of channels of image features and 3D queries, θₜ represents a frequency used in sinusoidal and cosine encoding methods to extend two-dimensional complex rotation to high-dimensional rotations corresponding to image and 3D query vectors, θₜₓ, θ_{ty}, θ_{tz}=10000^{-t/(d}^{_{head}}^{/6)}, t∈{0, 1, . . . , d_{head}/6}, and θₜₓ, θ_{ty}, θ_{tz} represent frequencies of rotations for position information of different axes, respectively;
dividing related image feature vectors and 3D query vectors obtained from images captured by the multi-view cameras through a convolutional neural network into three equal parts according to the number of channels to apply rotations of position information of different dimensions:
$${Q}_{x} = \{ {Q}_{1} , {Q}_{2} , … , {Q}_{n - 5} , {Q}_{n - 4} \}$$
$${Q}_{y} = \{ {Q}_{3} , {Q}_{4} , … , {Q}_{n - 3} , {Q}_{n - 2} \}$$
$${Q}_{z} = \{ {Q}_{5} , {Q}_{6} , … , {Q}_{n - 1} , {Q}_{n} \}$$
$${Q}_{x}^{′} = {Q}_{x} {e}^{i {θ}_{tx} {p}^{x}} , {Q}_{y}^{′} = {Q}_{y} {e}^{i {θ}_{ty} {p}^{y}} , {Q}_{z}^{′} = {Q}_{z} {e}^{i {θ}_{tz} {p}^{z}}$$
$${Q}_{ros} = cat ( {Q}_{x}^{′} , {Q}_{y}^{′} , {Q}_{z}^{′} )$$
wherein Qₓ, Q_{y}, Q_{z} represent the vectors divided into three parts, Q′ₓ, Q′_{y}, Q′_{z} represent vectors after rotation containing position information of each dimension, Qᵣₒₛ represents a vector obtained by concatenating three rotated vectors into a complete position embedding vector containing three-dimensional point position information, and cat represents concatenation;
processing embedding vectors of the image features and the 3D queries obtained from images captured by the multi-view cameras through a convolutional neural network by attention computation to represent a relative positional relationship between the image features and the 3D queries in an attention matrix:
$${A}_{( n , m )}^{′} = Re [ {q}_{n}^{′} {k}_{m}^{′ *} ] = Re [ {q}_{n} {k}_{m}^{*} {e}^{i ( n - m ) θ} ]$$
wherein A′_{(n,m)} represents the attention matrix after computation,
$${q}_{n}^{′} , {k}_{m}^{′ *}$$
represent rotated queries and keys, e^{i(n-m)θ} represents a result of the attention computation, and n and m represent two different positions.

7. The multi-view-based 3D object detection system according to claim 5, wherein in the multi-view-based 3D object detection method, setting the learnable parameter for the to-be-embedded 3D position information comprises:
$${P}_{α}^{3 d} = α ( {p}^{x} , {p}^{y} , {p}^{z} )$$
wherein
$${P}_{α}^{3 d}$$
represents adaptive 3D point position information, α represents the learnable parameter, and p^{y} and p^{z} represent 3D point positions.

8. The multi-view-based 3D object detection system according to claim 5, wherein in the multi-view-based 3D object detection method, fusing the pose geometric information of the multi-view cameras into the 3D position embedding 3DRoPE of the image under each view comprises:
calculating a pose [q̅ₙ, tₙ] of each-view camera using intrinsic and extrinsic parameters of the each-view camera, wherein q̅ₙ represents a quaternion vector indicating rotation, and tₙ represents a position vector;
capturing corresponding geometric attributes using a Fourier transform:
$$γ ( x \vert [ {f}_{l} , … , {f}_{k} ] ) = [ sin ( {f}_{l} π x ) , cos ( {f}_{l} π x ) , … ]$$
wherein γ( ) represents a Fourier transform function, [f₁, . . . , fₖ] are k frequencies evenly sampled from [0, fₘₐₓ], and x represents attributes of each camera pose;
mapping geometric attributes after the Fourier transform to dimensions corresponding to image features using a multi-layer perceptron (MLP):
$${G}_{n}^{e} = M L {P}_{enc} ( γ [ {\overline{q}}_{n} , {t}_{n} ] )$$
wherein
$${G}_{n}^{e}$$
represents pose geometric embedding of each-view camera, q̅ₙ represents a quaternion vector indicating rotation, and tₙ represents a position vector; and
adding
$${G}_{n}^{e}$$
to the position embedding to form a complete pose-enhanced position embedding.
